(19) United States
(12) Patent Application Publication
(10) Pub. No.: US 2024/0337523 A1
(43) Pub. Date: Oct. 10, 2024

(54) AUTONOMOUS INFANT SMART SCALE AND CHANGING TABLE

(71) Applicant: HB Innovations, Inc., Los Angeles, CA (US)

(72) Inventor: Peter Fornell, Los Angeles, CA (US)

(73) Assignee: HB Innovations, Inc., Los Angeles, CA (US)

(21) Appl. No.: 18/629,082

(22) Filed: Apr. 8, 2024

Related U.S. Application Data
(60) Provisional application No. 63/457,999, filed on Apr. 7, 2023.

(51) Int. Cl. G01G 19/44; A47D 5/00

(52) U.S. Cl. CPC G01G 19/445; A47D 5/00

(57) ABSTRACT

An infant smart scale weight tracking system combines an changing table and smart scale that automatically weighs a baby each time the baby is laid on a platform of the changing table. The infant smart scale weight tracking system may determine a measured baby weight, diaper weight, as well as track the same over time.

### CROSS-REFERENCE TO RELATED APPLICATIONS

This application claims priority benefit to U.S. Provisional Application No. 63/457,999, filed Apr. 7, 2023, the entirety of which is incorporated herein by reference.

### BACKGROUND

New parents worry more than ever about the health of their newborn children. Advancement in technology is starting to provide in-home devices that support various monitoring functions to allow parents to monitor babies. These devices can be complicated to employ and typically require significant involvement by parents. This reduces user compliance and collection of consistent monitored data. What is needed are better solutions to baby health monitoring.

### SUMMARY

An infant smart scale weight tracking system may combine an changing table and smart scale and be configured to automatically weigh a baby. The system may be configured to automatically weigh a baby each time the baby is laid on a platform of the changing table for a diaper change or other reason. The system or components thereof may be configured to determine a measured baby weight, diaper (stool and/or urine) weight, as well as track the same over time.

In one aspect, an infant smart scale system includes a smart scale comprising a platform integrated with a changing table; a weight sensor configured to detect weight applied to the platform; and a controller configured to control operations of the smart scale, the controller including a communication port configured to wirelessly connect with a user device, wherein the smart scale is configured to autonomously collect weight measurement data of babies during a changing event and transmit the weight measurement data to the user device.

In one example, the weight sensor comprises a pressure sensor, mechanical stress sensor, or vibration sensor.

In the above or another example, the weight sensor comprises a piezoelectric sensor.

In any of the above examples or another example, the system is configured to track weight of the baby over time.

In any of the above examples or another example, the controller is configured to receive weight measurement data from the weight sensor.

In any of the above examples or another example, the weight measurement data comprises processed measurement data including actual weight determined from removal of spikes. The user device may be configured to perform one or more operations selected from processing, analysis, monitoring, presentation, and/or data storage of the weight measurement data.

In any of the above examples or another example, the controller is configured to automatically tare the smart scale in a background operation upon placement of weight on the platform.

In any of the above examples or another example, the controller is configured to receive parameters that define a tare operation from the user device.

In any of the above examples or another example, the system includes a smart scale application configured to interface a user with operations of the smart scale via a user device, and wherein the smart scale application is configured to automatically generate historical weight charts showing measured weight over time.

In any of the above examples or another example, the system includes a smart scale application configured to interface a user with operations of the smart scale via a user device, and wherein the smart scale application is configured to automatically generate a presentation for display on the user device that includes a comparison of a measured weight with an expected weight based on historical measured weights of the baby or a baby population.

In any of the above examples or another example, the system is configured to utilize machine learning or artificial intelligence to increase accuracy of measured weight data.

In any of the above examples or another example, the system is configured to utilize machine learning or artificial intelligence to identify a baby positioned on the platform.

In either of the above examples or another example, the machine learning or artificial intelligence includes analysis of collected weight measurements determined from the weight measurement data. The analysis may include comparing a current weight measurement to weight measurements obtained from prior weight measurements to identify the baby. The analysis may consider a most recent measurement associated with previously identified babies to identify the baby. The analysis may consider weight measurements obtained prior to a current or most recent weight measurement for a baby to detect patterns in weight change and correlate the same with a current weight measurement. In one example, the analysis may correlate prior weight fluctuations represented in the detected patterns to determine a likely identity of the baby. The correlation may include time of day of the current weight measurement to time of day of prior weight measurements. In one configuration, the correlation includes identification of a timing pattern of urination or bowel movements of a particular baby or time period between diaper changes corresponding to time period pattern between urination or bowel movements. In one example, the analysis includes comparison of a current measured weight of contents of a diaper to previous measured weights of contents of diapers for identified babies.

In any of the above examples or another example, the system is configured to identify a baby positioned on the platform. The system may analyze one or more collected weight measurements determined from the weight measurement data to identify the baby positioned on the platform. The analysis may include comparing a current weight measurement to weight measurements obtained from prior weight measurements to identify the baby. The analysis may consider a most recent weight measurement associated with previously identified babies to identify the baby. The analysis may consider weight measurements obtained prior to a current or most recent weight measurement for a baby to detect patterns in weight change and correlate the same with a current weight measurement. The analysis may correlate prior weight fluctuations represented in the detected patterns to determine a likely identity of the baby. The correlation may include time of day of a current weight measurement with time of day of prior weight measurements. The correlation may include identification of a timing pattern of urination or bowel movements of a particular baby or time period between diaper changes corresponding to a time period pattern between urination or bowel movements. The analysis may include comparison of a current measured weight of contents of a diaper to previous measured weights of contents of diapers for identified babies.

In any of the above examples or another example, the system is configured to detect diaper changes and weight of diaper and/or contents to aid in tracking of diaper changes and to gain a deeper understanding of digestive functions, urination and bowl movements.

In any of the above examples or another example, the system is configured to synchronize the collected measured weight data with a smart scale application configured to interface a user with the collected measured weight data via a user device for on demand generation of presentation of the measured weight data.

In any of the above examples or another example, the system further includes a wake sensor configured to detect weight applied to the platform, motion of the platform, presence of the baby on the platform, or combination thereof, wherein receipt of a wake signal by the controller from the wake sensor causes the controller to transition the smart scale from a power saving mode to an operation mode. Following the transition from the power saving mode to the operation mode the controller may be configured to autonomously tare the smart scale. Following the transition from the power saving mode to the operation mode the controller may be configured to scan for a user device. If the scan results in connection with the user device, the controller automatically transmits weight measurement data to the user device. The controller may store collected weight measurement data in a buffer prior to connecting with the user device. The wake sensor may comprise an accelerometer configured to detect motion of the platform motion of the platform

In any of the above examples or another example, the controller or user device using the smart scale application is configured to process the weight measurement data to determine one or more actual weights. The one or more actual weights may include preliminary actual weight subject to further processing by back end processing. The back end processing may apply one or more algorithms to refine the preliminary actual weights. The one or more algorithms include spike removal. The back end processing may include stage identification, baby identification, comparative weight history analysis with respect to the baby or baby population, or combination thereof. One or more of stage identification, baby identification, and/or spike removal may be utilized to determine the one or more actual weights. The determined actual weights may be used for stage identification, baby identification, or both.

In any of the above examples or another example, the weight measurement data comprises processed measurement data including actual weight determined from removal of spikes beyond threshold values set relative to a mean weight measurement for each stage of the changing event or a percentage of a mean weight measurement for each stage of the changing event.

In any of the above examples or another example, the system is configured to process the weight measurement data including graphing the weight measurement data collected during the changing event and removing min and max spikes to identify weight in each stage of the changing event. The max and min weight values may be set as threshold amounts or percentages of a mean weight during an identified stage or changing event.

In one embodiment, the system does not have a wake sensor and the smart scale is configured to turn on periodically to determine if weight is applied to the platform and thereafter tare the smart scale and scan for the user device.

### BRIEF DESCRIPTION OF THE DRAWINGS

For a more complete understanding of the present disclosure and its features and advantages, reference is now made to the following description, taken in conjunction with the accompanying drawings, in which:

FIG. 1 is a semi-schematic of a smart scale weight tracking system according to various embodiments described herein;

FIGS. 2A-2E illustrate a smart scale according to various embodiments described herein;

FIG. 3 is a schematic of an embodiment of a smart scale weight tracking system according to various embodiments described herein; and

FIG. 4 illustrates operational algorithms of the smart scale weight tracking system according to various embodiments described herein.

### DESCRIPTION

An infant smart scale weight tracking system may include an smart scale configured to measure weight of a baby. In various embodiments, the smart scale may be integrated with a baby changing table that includes a platform on which a baby may be positioned changed or otherwise cared for during a weighing event. The smart scale may be operatively coupled to the platform for measuring weight positioned on the platform.

Babies move around unpredictably, making it difficult to obtain an accurate weight when using current weight scales. Current changing table scales require the baby to remain still for a period of time to allow the scale to lock into the weight of the baby. This may be signaled by a beep or other indication to notify the user of the lock-in of weight. In various embodiments, the operation of the system, including the weight measurement operations, may be configured to work autonomously in the background to measure weight, without user interaction from the caregiver during a diaper change process or in some instances at all. This autonomous operation may beneficially allow a parent or caregiver to focus on the baby and related activities rather than operating the smart scale. The system may further be configured to autonomously track measured weights over time.

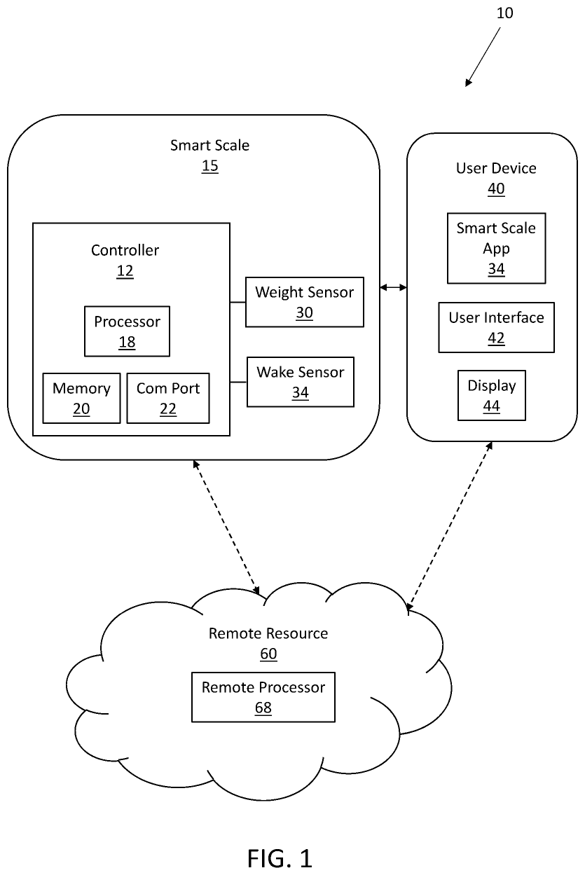

FIGS. 1-4 illustrate various components and operations of an infant smart scale weight tracking system 10 according to various embodiments wherein like features are identified by like numbers.

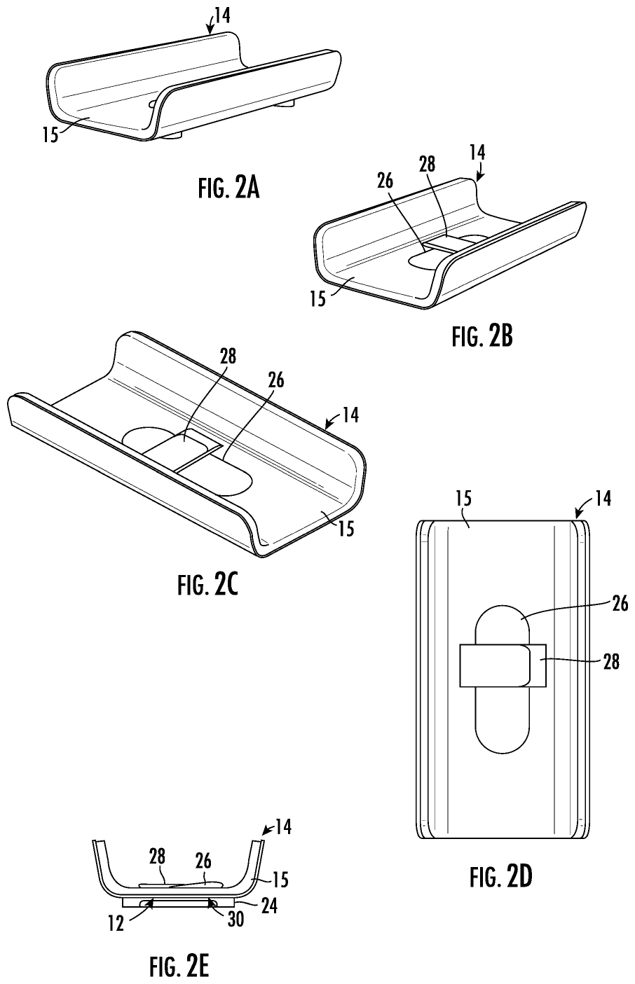

With particular reference to FIG. 1, in various embodiments, the system 10 may include a controller 12 configured to control operations of the system 10, such as those of a smart scale 14. The smart scale 14 may include a platform 15 onto which a baby may be placed and from which applied weight may be measured. In some embodiments, the smart scale 14 is integrated in a changing table 16 (see FIGS. 2A-2E) such that the platform 15 also serves as a surface upon which a baby may be changed. Integration with a changing table 16 allows autonomous tracking of baby weight as well as diaper weight, such as weight of stools and urine. The controller 12 may include a processor 18 and memory 20. The memory 20 may store instructions that when executed by the processor 18 performs operations of the processor 18 may be local and/or remote to the smart scale 14. In the illustrated embodiment, the controller 12 is housed in, integrated with, or otherwise in communication with the smart scale 14 to control operations thereof. In one embodiment, the controller 12 includes a communication port 22 including a receiver, transmitter, and/or transceiver configured for wired or wireless communication with components of the system 10 or other devices and/or resources in communication with the system 10.

The smart scale 14 may include one or more weight sensors 30 operatively coupled to a platform 15 to measure weight placed thereon. Weight sensor 30 may include any suitable weight sensor 30, such as pressure sensors, mechanical stress sensors, and/or vibration sensors. In some embodiments, the weight sensor 30 may include one or more piezoelectric sensors.

The controller 12 may be configured to receive measurement data from the weight sensor 30. In one example, the controller 12 may include or be configured to process all or a portion of the weight measurement data received from the weight sensor 30. In some embodiments, the memory 20 may include a weight data storage component for temporary or long term storage of measured weight data collected by the smart scale 14.

In one configuration, the controller 12 is configured to receive instructions from and/or transmit measurement and/or other data to a user device 40, such as a smart phone, tablet, desktop, portable computer, stationary computer, or dedicated device. The user device 40 may be configured to receive raw measurement data collected by the weight sensor 30 and perform one or more processing, analysis, monitoring, presentation, and/or data storage operations described herein. As described in more detail below, in some embodiments, receipt of the data and one or more of the associated operations may be automatic or otherwise performed in the background without user interaction. The user device 40 may include a processor and memory including instructions that when performed by the processor perform operations of the user device 40. It is to be appreciated that unless stated otherwise processing operations performed by the user device 40 may be performed locally, remotely, e.g., via a remote resource 60 cloud computing environment, or hybrid.

In some embodiments, the system 10 may include or incorporate a program or app configured to interface the user with operations of the smart scale 14 and/or output measurements and associated processing thereof. For example, the user device 40 may be configured to execute, run, or electronically interact with operations of a smart scale application 50 configured to perform or provide instructions to the controller 12 with respect to one or more operations of the controller 12 described herein. It is to be understood that the smart scale application 50 may be any suitable application program, computer program, suite, or the like comprising instructions that when executed by a processor causes the user device 40 to perform the corresponding operations described herein. The user device 40 may be configured to store received and/or generated measurement data locally or remotely in a data storage medium. In one example, the user device 40 comprises a user interface 42 operable to control operations of the controller 12 and interact with measurement data and generated presentations, e.g., for display on a display 44.

As introduced above, in some embodiments, the system 10 may include or incorporate a remote resource 60 that performs one or more data processing, updating, data storage, and/or data presentation generation operations. The remote resource 60 may include one or more of a remote processor 68, data storage, population analysis processing, or the like, configured to support and/or expand the operations of the system 10. In some embodiments, all or a portion of the remote resource 60 is provided by or in data communication with the user device 40. The remote resource 60 may include a server accessible via a wireless or wired communication network, such as a LAN, PAN, WLAN, or WAN. In one embodiment, the remote processor 68 and/or user device 40 operates in a cloud computing environment. As shown in FIG. 1, inclusion or utilization of a remote resource 60 may be optional. Indeed, some embodiments of the system 10 may be configured to operate autonomously without the use of a remote resource 60. In such configurations, the user device 40, controller 12, or both, may be configured to perform operations described herein with respect to a remote resource 60. In one embodiment including a remote resource 60, the controller 12 does not communicate directly with the remote resource 60 and the user device 40 operating the smart scale application 50 may communicate with the remote resource 60 to one or more of transmit measurement data received from the controller 12, transmit data request, e.g., for historical weight data, population weight data, comparison charts, or the like, and/or receive software/firmware updates for updating the controller 12. In one embodiment, the controller 12 is configured to transmit measurement data to a remote resource 60 for processing and/or comparison or inclusion with population data comprising measurement data alone or together with other related data from a plurality of smart scale systems 10 or smart scales 14 thereof. All or a portion of the smart scale application 50 may be stored on the user device 40 or another device, such as the smart scale 15, remote resource 60, or server, through which the user device 40 interfaces to utilize the operations of the smart scale application 50.

The controller 12, user device 40, and/or remote resource 60 may be configured to receive raw measurement data collected by the weight sensor 30 and perform one or more processing operations such as performing calculations, generating data presentations, and/or performing data analysis as described herein. In one example, the user device 40 is configured to transmit data to the remote resource 60 to perform one or more of the processing operations described herein. In one example, the user device 40 when executing instructions provided by the smart scale application 50 may be configured to receive raw measurement data, processed measurement data, analyzed measurement data, measurement or stage determination algorithms and associated data, or other data or instructions from the controller 12. As noted above, the processor 18 of the user device 40 may be utilized as all or part of a remote processor 68 for performing the various processing operations described herein.

In one embodiment, the controller 12 is configured to automatically tare the smart scale 14 weight measurement operations in the background. The tare operations may include, for instance, accounting for drift, such as when an object such as a towel or blanket is positioned on the changing table 16 platform 15. In some embodiments, a user device 40, which may be executing, running, or communicatively interacting with the smart scale application 50, may be operable to define, initiate, participate, or otherwise control one or more tare operations of the smart scale 14. For example, the user device 40 may interface the user with control of or defining parameters of taring of the smart scale 14. In one configuration, the user device 40 may communicate with the controller 12 to control one or more tare operations in the background, without active user interaction, based one predefined setting provided by a user and/or smart scale application 50.

As introduced above, the system 10 may be configured to monitor, track, process, analyze, and/or store measurement data. The controller 12 and/or user device 40 may be further configured to output the raw, processed, and/or analyzed data for viewing and/or interaction by a user, e.g., via one or more user devices 40 and/or displays 44 or peripherals thereof. In one configuration, the system 10 is configured to save measurement data in one or more databases and/or accesses the measurement data from one or more databases. Databases may be local to the smart scale 14, user device 40, or comprise a remote resource 60 that is configured to be in communication with the smart scale 14, user device 40, or other device executing the smart scale application 50 to receive and transmit measurement data for storage and retrieval. In some embodiments, the user device is configured to transmit measurement data to a remote resource for further processing, which may include further analysis, population comparison, archiving, or the like. In one embodiment, measurement data is saved and made accessible to a user via the user device 40 to subsequently view historical weight data. The smart scale application 50 may be configured to automatically generate historical weight charts showing weight over time, comparison with expected weight or population, or the like. In some embodiments, the historical weight data may be provided with comparison charts. In one embodiment, measurement are automatically or upon instruction from a user saved to a database and/or backend operation so the user can view historical data and see comparison charts for standardized weights.

In various embodiments, the system 10 may utilize machine learning to increase accuracy of data and to improve the data measurements. For example, the system 10 may utilize machine learning or artificial intelligence to identify a baby placed on the smart scale 14, differentiate between multiple babies that use the smart scale 14. In general, baby weight does not significantly change over short periods of time, such as a day or a couple days or week. In various embodiments, analysis of collected weight measurements may include comparing a current weight obtained to prior measurements to identify a baby, which may include from a population of known babies. The analysis may consider most recent measurements to identify the baby. In a further or another example, the analysis may consider measurements obtained prior to a current or most recent measurement for a baby to detect patterns in weight change to correlate the same with the measurements obtained. The analysis may correlate prior weight fluctuations to determine a likely identity of the baby. For instance, the analysis may consider and/or correlate the time of day the measurement is obtained with prior measurements obtained at similar time of day. Time of day may in some instances be used to identify a timing pattern of urination or bowel movements of a particular baby. Other patterns may be used, such as time period between diaper changes corresponding to time period pattern between urination or bowel movements. In some embodiments, analysis may consider and/or compare an identified weight of diaper contents to assist in identity identification, which may or may not consider time of day. The measurement analysis may be local to the smart scale 14 or remote, e.g., a processing resource such a user device 40, server, cloud computing, or other suitable processing resource may be used. When an analysis of measurement data identifies a baby, the system 10 may associate the measurement with the identified baby in the system 10, which may then be provided to frontend and/or backend operations, e.g., for presentation, further analysis, and/or storage. In various embodiments, the above analyses do not incorporate machine learning or artificial intelligence.

In various embodiments, the smart scale 14 weight tracking system 10 may be configured to detect diaper changes and weight of diaper and/or contents, to aid in tracking of diaper changes and to gain a deeper understanding of digestive functions, urination and bowl movements. In one embodiment, the smart scale 14 weight tracking system 10 may utilize machine learning or artificial intelligence to detect diaper changes and weight of diaper and/or contents, to aid in tracking of diaper changes and to gain a deeper understanding of digestive functions, urination and bowl movements.

In one example, the measured weight data autonomously collected may be synchronized with the smart scale application 50 for on demand generation of presentation of the weight data and various analyzes thereof on the user device 40, e.g., wireless device or mobile phone, to track weight automatically in the background. For example, the controller 12 may receive measurement data from the weight sensor 30 and transmit the measurement data to the user device 40 and/or a remote resource 60 for processing, e.g., via a user device 40 processor or remote processor, and/or storage, e.g., in a storage device of or accessible to the user device 40 or a remote storage device or database. In one configuration, the user device 40 may transmit measurement data to a remote resource 60 or perform all or a portion of the operations described herein with respect to a remote resource 60. For example, the remote resource 60 may comprise a remote processor in communication with the controller 12 and/or user device 40, which may include a cloud computing environment. Using the smart scale application 50, the user device 40 may be configured to access the analyzed and/or stored data for presentation on the user device 40.

The smart scale 14 may be powered by any suitable power source, such as a battery 32, which may include a rechargeable battery, or residential a/c. In one embodiment, the smart scale 14 includes a battery 32. The controller 12, may be configured to operate the battery 32 in an advanced power saving mode. This may beneficially avoid using power cables attached to changing table 16 to provide power in use. In one embodiment, the controller 12, which may include a wired circuit of the smart scale 14, for example, may be configured to detect electrical signals from a wake sensor 34 configured to detect motion of the platform 15 or presence of a baby thereon. Example wake sensors 34 may include a weight sensor to detect weight applied to platform, which may be the same or in addition to weight sensor 30, vibration or motion sensor to detect motion of the platform, capacitance sensor to detect a change in capacitance of the platform or adjacent field, or an optical sensor to detect a change in light and/or motion of an object above the platform operatively coupled to the platform 15 for detection presence on and/or movement of the platform 15, which in some configurations may correspond to a change in weight applied to the platform 15, to cause the battery 32 to wake up. Example motion sensors may include electrical contacts that contact when the platform moves, optical sensor that detects a change in light when the platform, accelerometer, or piezoelectric sensor. The controller 12 may utilize a capacitor, power reserve, small rechargeable battery, piezoelectric weight sensors, or other suitable power source configured to provide power to detect weight changes and cause termination of power saving mode operation and wake up the smart scale 14 for full operations. In this or another embodiment, the controller 12 may be configured to wake up the smart scale 14 periodically, e.g., a predefined time intervals, such as one or more times a second or every two or three seconds.

FIGS. 2A-2E illustrate various views of a smart scale 14 according to various embodiments. The smart scale 14 may include a platform 15 for supporting a baby. The platform 15 may be operatively coupled to a weight sensor 30. The weight sensor 30 may include any suitable weight sensor 30, such as pressure sensors, mechanical stress sensors, and/or vibration sensors. In some embodiments, the weight sensor 30 may include one or more piezoelectric sensors. The weight sensor 30 may be integrated within the platform 15 or positioned below the platform 15, e.g., between a base 24 that supports the platform 15 and the platform 15. In the illustrated embodiment, the smart scale 14 also includes various optional components. For example, a pad 26 for providing a padded location to place babies is positioned on the platform 15. A securing strap 28 configured to wrap around a baby to securely retain a baby on the platform 15 is secured also attached to the platform 15. As noted above, the smart scale 14 may include a controller 12. In some embodiments, the smart sensor may also include various other components such as a battery 32 and/or wake sensor 34. These components may be housed within the platform 15 or incorporated within the base 24 or may be separate and connectable to the platform 15 or controller 12, for example. In one embodiment, all or part of the controller 12 is separate from the platform 15 and weight sensor 30 and the controller 12 is configured to communicate with the weight sensor 30 via corresponding communication ports. In some embodiments, the smart scale 14 is configured to be powered by residential electrical connections and includes a plug for such purpose. In embodiments wherein the smart scale 14 also includes a battery 32, the smart scale 14 may be configured to charge the battery 32 when plugged in.

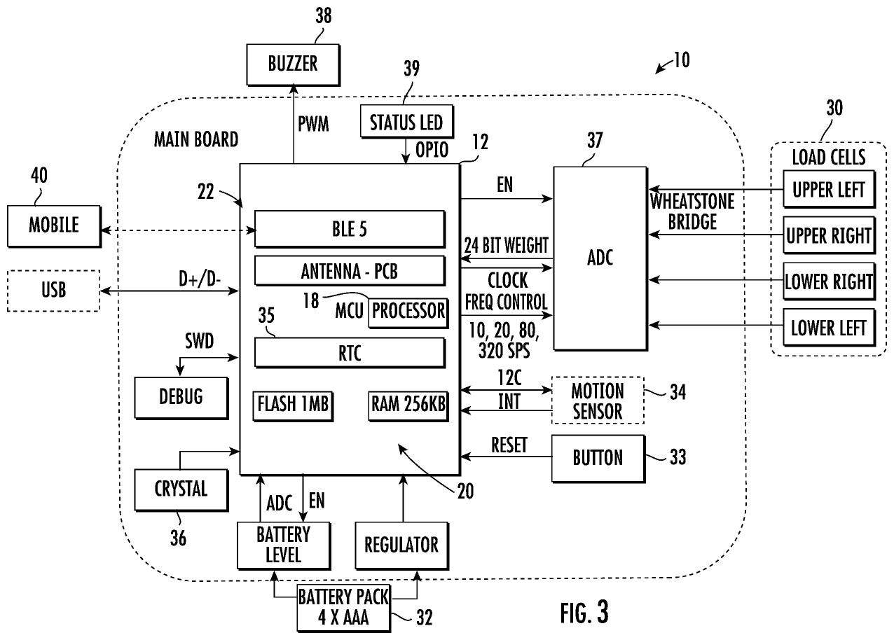

FIG. 3 illustrates an example system 10 according to various embodiments. In this example, the controller 12 includes a microcontroller unit including a processor 18 and memory 20 to store instructions for execution by the processor 18 and for performing operations of the controller 12. The memory 20 includes flash memory and RAM, but other memory schemes may be used. The controller 12 may also include a real time clock 35 for accurate tracking of time. The controller 12 may also utilize a crystal oscillator 36. A communication port 22 comprising a BLE chip is also provided for wireless communication with a user device 40, but other wireless communication port configurations may be used. In the illustrated embodiment, the user device 40 comprises a mobile device, such as a smart phone or tablet, configured to communicate with the controller 12 via the communication port 22, which is configured to utilize Bluetooth Low Energy protocol via the BLE chip, but, as noted above, other wireless communication techniques may be used. The communication port 22 may also include a wired data port for receiving and transmitting data via a wired connection, such a USB connection and protocol. It is to be appreciated that the controller 12 may include a microcontroller, microprocessor, system on chip, or other suitable technology to perform the operations of the controller 12.

The controller 12 may be configured to couple to a battery 32. The battery 32 may be internal or external to the smart scale 14. In some embodiments, the controller 12 may be configured with a connection to receive a supply of residential a/c current or other supply of power to power the smart scale 14 and/or charge the battery 32. For example, a USB connection and power supply protocol may be used.

The system 10 may optionally include a wake sensor 34 configured to wake the controller 12 from a power saving mode. As shown, the wake sensor 34 comprises a motion sensor. The motion sensor is configured to detect motion of the platform 15 (see, e.g., FIGS. 2A-2E). In one example, the motion sensor may comprise an accelerometer.

The smart scale 14 also includes a weight sensor 30 to detect weight positioned on the platform 15. In the illustrated embodiment, the weight sensor 30 includes multiple load cells, four in this configuration. The signals from the weight sensor 30 are initially processed through an analog to digital converter 37 for handling by the controller 12.

The smart scale 14 may include various interface features such as speakers, displays, lights, buttons, or the like. As shown, the controller 12 is be configured to couple to an audio signaling device 38, such as a buzzer, speaker to output sounds, e.g., to indicate warnings, notifications, battery power, operation mode, weight measurement lock, or the like. A light signaling device 39 or display may be used in addition to or alternative to an audio signaling device 38 in order to provide information to users, such as status, warnings, notifications, weight measurement lock, weight measurements, battery power, operation mode, and the like. In the illustrated embodiment, the light signaling device 38 comprises an LED configured to illuminate to communicate status of the smart scale 14. The controller 12 may also include a reset button 33 allowing a user to reset operations of the smart scale 14.

In various embodiments, the user device 40 operating the smart scale application 50 is configured to receive the initial raw weight measurement data from the controller 12 and perform initial processing calculations before being sent to backend components or services, such as a remote resource 60 for further processing. For example, the controller 12 and/or user device 40 may comprise a front end device that receives raw measurement data directly or indirectly from the weight sensor 30 and perform initial processing and/or analysis and transmits the resulting data to the back end for further processing to determine/calculate more precise weight based on algorithms. Initial processing may include, for example, analog to digital conversion. In various embodiments, processing may include, for example, one or more of stage identification, baby identification, and/or spike removal. In some embodiments, initial analysis operations are preliminary analyses. Algorithms described herein with respect to stage identification, baby identification, and/or spike removal may be performed by front end components, back end components, or both. As noted above, the user device 40 may comprise all or a portion of a remote resource 60 and processing functions of the user device 40 may be utilized to perform front end operations, back end operations or both. Back end components may similarly be configured to perform initial processing in addition to or in alternatively to the front end components. In some embodiments, front end components perform the initial processing and further processing operations. In some examples, the operations described herein with respect to one or both of the user device 40 or remote resource 60 are performed by the controller 12, a smart device, IoT device, a dedicated data collection/calculation device, and/or other suitable device. In one embodiment, the controller 12 is configured to communicate with or is integrated with a smart bassinet controller such as that described in U.S. patent application Ser. No. 14/448,679, filed Apr. 31, 2014, or U.S. patent application Ser. No. 15/055,077, filed Feb. 26, 2016, PCT/US2017/057055, filed Oct. 17, 2017, all of which are hereby incorporated herein by reference.

As described in more detail below, the system 10 may be configured to apply various algorithms to process and analyze the measurement data collected during a changing event. For example, algorithms may consider weight change overtime during a changing session, e.g., in stages: initial stage of weight detected corresponds to baby in dirty diaper, subsequent stage corresponds to baby without diaper, subsequent stage corresponds to baby with clean diaper. In one example, a mean weight in each stage may be determining. In another example, an average weight at each stage may be used. In one example, initial processing or post processing algorithms may be configured to remove weight spikes based on duration, e.g., less than a second. Additionally or alternatively, max and min weight values may be removed as corresponding to movement and/or caregiver leaning on changing table 16. The max and min weight values may be set as threshold amounts or percentages of a mean or an average weight during an identified stage or changing event. In one example, front end or back end processing may include graphing weight measurements during a changing event and removing min/max spikes to identify weight in each stage. In one example, the processing includes identifying similarities in measurements overtime and/or repeated weight measurement values obtained during a stage.

In various embodiments, stage identification, as a front end and/or back end process, may include combining measured weight values with chronological time from initial weight detection to cessation of weight detection. In one configuration, further processing of measurement data, e.g., by a back end process, may include baby identification. Baby identification may include analysis of historical data to identify the baby, which may further include utilization of the identity of the baby to assist in weight determination. For example, identification the identity of the baby may assist in filtering minor spikes or oscillations in weight signals to lock in on putative weights for further analysis and/or final weight determinations, e.g., in consideration of recent weights of the identified baby and/or patterns of calculated weight for the baby, such as relevant time. In various embodiments, the front end may receive data/statistics related the calculated weights from the back end, which may include weight analysis over time determined from historical weight determinations associated with an identified baby for selective presentation on the user device 40.

As introduced above, in some embodiments, the system 10 may be configured to calculate weight of the baby over the course of several stages of a diaper changing process. For example, an initial stage, or first stage, may correspond to when a baby is initially placed on the scale/changing table 16 for a diaper change. A second stage may correspond to when the baby's full diaper has been removed and the baby is lying on the scale/changing table 16 while not wearing a diaper. The subsequent stage, or third stage, may correspond to when a clean diaper has been placed on the baby.

Different methodologies for determining the stage of the measurement and weight calculations at each stage may be used. For example, the system 10 may utilize spike (high/low) detection of weight measurements to identify a stage of a diaper changing process. In one embodiment, the system 10 may collect weight measurements continuously or substantially continuously, e.g., a few measurements per second or more, over a period of time and plot a graph of the weight measurements over time. In one embodiment, the system 10 may be configured to detect and classify spikes for stage identification. For example, the system 10 may identify the various stages of the changing process based on analysis of amplitude and/or frequency of spikes in the weight measurement. For example, spikes may be caused by events in the diaper changing process such as the baby moving during the weight measurement, the caretaker leaning on the platform 15 in the process of removing the baby's soiled diaper, or the caretaker lifting the baby by the baby's legs in order to place the clean diaper underneath the baby. The system 10 may be configured to recognize patterns in the spikes for classification such as duration of spike, spike amplitude relative to other detected spikes, frequency and amplitude differences between spikes, or the otherwise. The patterns or pattern criteria may be pre-programmed and/or learned. As caregivers may change babies differently and babies may react differently, the system 10 may be configured to learn pattern specific nuances with respect to a caregiver, group of caregivers, baby and/or group of babies to improve accuracy of stage identification. In a further example, the system 10 may be configured to identify stages by removing spikes and identifying potential or preliminary weight measurements, as described below and elsewhere herein, and tracking the change or rate of change in the weights indicative of each stage.

In some embodiments, after identification of stage based on detection and classification of spikes, the system 10 is configured to remove the spikes from the measurement before determining the weight of the baby during each stage. In another embodiment, the system 10 may determine weight during each stage, which may be prior to a successive stage. In one configuration, the system 10 is configured to calculate one or more potential weights at each stage and compare the potential weights obtained during a stage and/or the potential weights obtained between each stage to calculate a probable or final weight at each stage.

In one embodiment, the system 10 may be configured to calculate the weight of the baby by computing an average or mean weight measurement at each stage. In one example, the system 10 may calculate the weight of the baby at each stage by median weight obtained during the stage. As another example, the system 10 may calculate weight of the baby at each stage by computing either a simple moving average or a weighted moving average of the weight measurements obtained at each stage.

In one embodiment, the system 10 is configured to determine the weight of the baby during a first stage of the diaper changing process by calculating a mean or average weight measurement collected during the first stage over a period of x seconds and storing that value as representing the weight (preliminary, probable, or final) of the baby with a soiled diaper. The system 10 may determine the weight of the baby during a second stage of the diaper changing process by calculating the mean or average weight measurement collected during the second stage over a period of y seconds and storing that value as representing the weight (preliminary, probable, or final) of the baby without a diaper. The system 10 may determine the weight of the baby during a third stage of the diaper changing process by calculating the mean or average weight measurement collected during the third stage over a period of z seconds and storing that value as representing the weight (preliminary, probable, or final) of the baby with a clean diaper.

From the weight measurements obtained, the system 10 may be configured to perform various computations. For example, the weight of the baby's bowel movement/excretions may be determined by subtracting the average or mean weight over time from the third stage, representing the weight of the baby while wearing a clean diaper, from the average or mean weight over time from the first stage, representing the weight of the baby while wearing a soiled diaper.

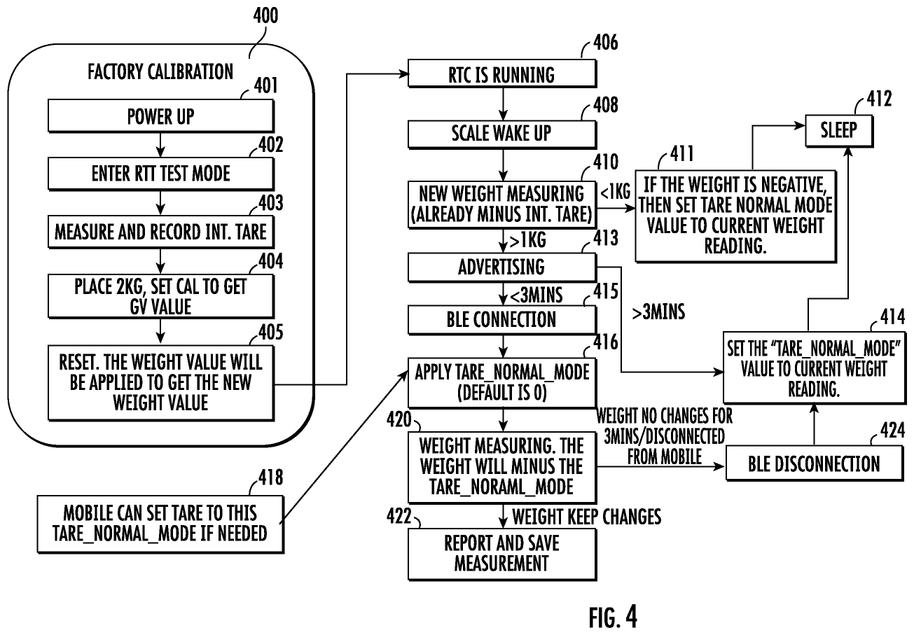

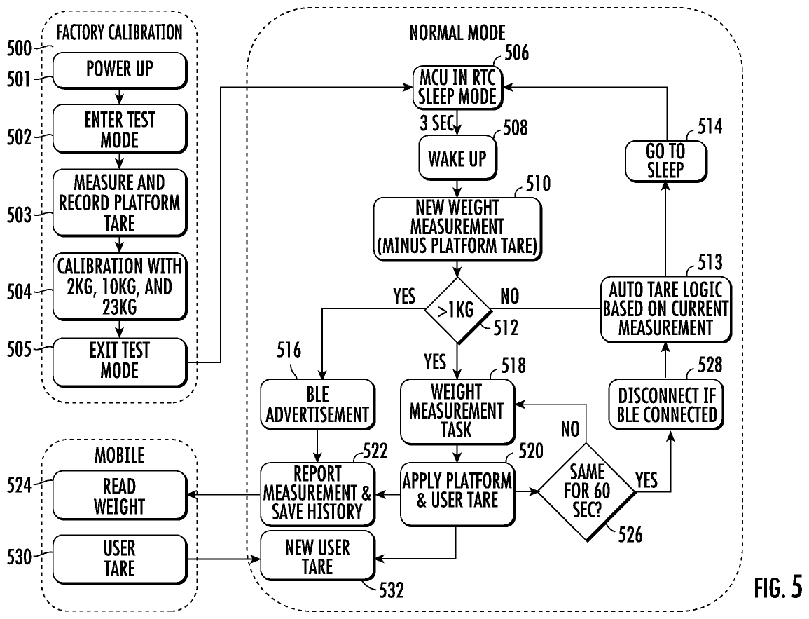

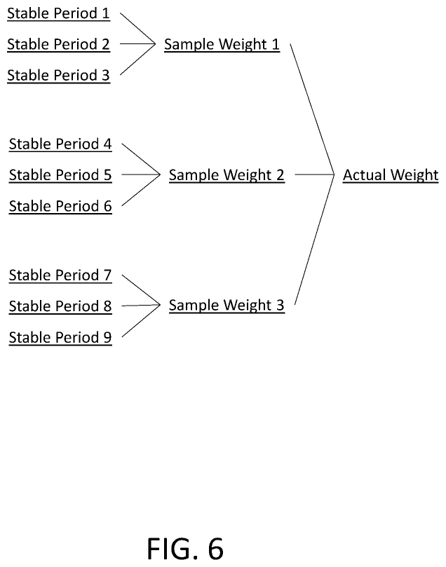

As introduced above, the smart scale 14 may be configured to automatically takes measurements without user interaction. With further reference to FIG. 4, the smart scale 14 may include a battery or power saving mode including a sleep state wherein the controller 12 wakes the smart scale 14 in response to signals from a wake sensor 34. The wake sensor 34 may detect presence, weight change, or motion with respect to the platform 15 of the smart scale 14. For example, the wake sensor 34 may comprise an accelerometer that detects movement if the platform 15 corresponding to a change in weight and outputs a signal that wakes the smart scale 14 or controller 12 thereof.

In various embodiments, a duration of weight change is used by the controller 12 to determine if further actions, such as setting tare, or taking additional measurements and/or transmitting measurement data for processing should take place. For example, if a detected weight change does not persist for a period of x seconds, the controller 12 may determine that the baby was not put on the platform 15 or the cause of the initial change in weight or wake signal. In some embodiments, the controller 12 may include an analog to digital converter 37 to process analog signals received from the weight sensor 30 to digital for generation of raw measurement data. In various embodiments, this may be performed on signals received from the weight sensor 30 at wake or upon determination of a persistent weight change. If the weight change is stable, the controller 12 may perform a tare operation to automatically tare the scale. For example, the controller 12 may reset the current weight of the system 10 to 0 to remove the effect of the object in the scale for the next measurement. When a baby is determined to be on the scale, the controller 12 may be configured to take measurements x times per second for y seconds. In one configuration these measurements are stored in a buffer. The controller 12 may then start scanning, e.g., via the communication port 22, for a user device 40. In one example, the controller 12 scans using a wireless technology/protocol, such as Bluetooth Low Energy protocol. If the user device 40 is detected, the controller 12 may start to automatically upload the measurements or transmit the measurements to the user device 40 for upload. As the baby is likely to move around while being changed, the controller 12 may be configured to measure the weight every x seconds and transfer the measurements to the user device 40 in the background. The measurements transmitted and/or uploaded may comprise raw measurement data; however, in some embodiments, the measurements may undergo further processing prior to transmission and/or upload.

The user device 40 may be configured to further process the measurement data to calculate actual weight based on the measurement data. Calculation of actual weight may include application of an algorithm to the measurement data collected during the changing event. As described above and elsewhere herein, the algorithm may incorporate or consider identity, stage, spike detection, duration, mean, average, time of day, baby specific history, among others. In one example, the algorithm analyzes patterns in measured weight oscillations such as with respect to duration, mean, or average of the weight fluctuations and which may further incorporate stage identification and/or baby identity. In a further example, a min and max threshold may be calculated based on duration and/or similarity of a range of measurements, which may include consideration of an expected weight range of the baby based on identification, prior weight measurements, weight measurements in another stage of the same changing event, or expected standard weight within the baby population whereby spikes outside the threshold range are removed prior to further oscillation analysis with respect to one or more of duration, mean, or average to determine actual weight. As noted above, in some embodiments, the actual weight determination may be a preliminary actual weight subject to further processing, which may be performed by back end processing, such as stage identification, baby identification, comparative weight history analysis with respect to the baby or baby population. In one example, post processing maintains the preliminary actual weight for stage identification and hence identification of baby weight (stage 2), diaper weight (stage 3−stage 2), and urine or stool weight (stage 1−stage 3). In some embodiments, the user device 40, via operation of the smart scale application 50, may also be configured to set the tare. In one embodiment, the controller 12 may automatically initiate sleep mode x seconds after weight has been removed or measured stable.

The present disclosure describes various system components. Such components may include functionally related hardware, instructions, firmware, or software. The components may include physical or logical groupings of functionally related applications, services, resources, assets, systems, programs, databases, or the like. The components and/or hardware storing instructions or configured to execute functionalities of the components may be physically located in one or more physical locations. For example, components may be distributed across one or more networks, systems, devices, or combination thereof. It will be appreciated that the various functionalities of these features may be modular, distributed, and/or integrated over one or more physical devices. It will be appreciated that such logical partitions may not correspond to physical partitions of the data. For example, all or portions of various components may reside or be distributed among one or more hardware locations.

Various embodiments described herein may include a machine-readable medium containing instructions for performing the operations and functionalities described herein. The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure. The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of the systems, associated components, and processes that might make use of the structures described herein. Other arrangements may be utilized and derived therefrom, such that structural and logical substitutions and changes may be made without departing from the scope of this disclosure. Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims to which this disclosure accompanies.

What is claimed is:

1. An infant smart scale system, the system comprising:
a smart scale comprising a platform integrated with a changing table;
a weight sensor configured to detect weight applied to the platform; and
a controller configured to control operations of the smart scale, the controller including a communication port configured to wirelessly connect with a user device,
wherein the smart scale is configured to autonomously collect weight measurement data of babies during a changing event and transmit the weight measurement data to the user device.

2. The system of claim 1, wherein the controller is configured to automatically tare the smart scale in a background operation upon placement of weight on the platform.

3. The system of claim 2, wherein the controller is configured to receive parameters that define a tare operation from the user device.

4. The system of claim 1, wherein the system further includes a smart scale application configured to interface a user with operations of the smart scale via a user device, and wherein the smart scale application is configured to automatically generate historical weight charts showing measured weight over time.

5. The system of claim 4, wherein the smart scale application is configured to automatically generate a presentation for display on the user device that includes a comparison of a measured weight with an expected weight based on historical measured weights of the baby or a baby population.

6. The system of claim 1, wherein the system is configured to identify a baby positioned on the platform.

7. The system of claim 6, wherein the system analyses one or more collected weight measurements determined from the weight measurement data to identify the baby positioned on the platform, wherein the analysis includes comparing a current weight measurement to weight measurements obtained from prior weight measurements to identify the baby.

8. The system of claim 7, wherein the analysis considers weight measurements obtained prior to a current or most recent weight measurement for a baby to detect patterns in weight change and correlate the same with a current weight measurement, where the analysis correlates prior weight fluctuations represented in the detected patterns to determine a likely identity of the baby.

9. The system of claim 8, wherein the correlation includes one or more of:
time of day of a current weight measurement with time of day of prior weight measurements;
identification of a timing pattern of urination or bowel movements of a particular baby or time period between diaper changes corresponding to a time period pattern between urination or bowel movements; and
analysis includes comparison of a current measured weight of contents of a diaper to previous measured weights of contents of diapers for identified babies.

10. The system of claim 1, wherein the system is configured to detect diaper changes and weight of diaper and/or contents to aid in tracking of diaper changes and to gain a deeper understanding of digestive functions, urination and bowl movements.

11. The system of claim 1, further including a wake sensor configured to detect weight applied to the platform, motion of the platform, presence of the baby on the platform, or combination thereof, wherein receipt of a wake signal by the controller from the wake sensor causes the controller to transition the smart scale from a power saving mode to an operation mode.

12. The system of claim 11, wherein following the transition from the power saving mode to the operation mode the controller is configured to autonomously tare the smart scale.

13. The system of claim 11, wherein following the transition from the power saving mode to the operation mode the controller is configured to scan for a user device, wherein if the scan results in connection with the user device, the controller automatically transmits weight measurement data to the user device.

14. The system of claim 1, wherein the controller or user device using the smart scale application is configured to process the weight measurement data to determine one or more actual weights.

15. The system of claim 14, wherein the one or more actual weights comprise preliminary actual weight subject to further processing by back end processing, wherein the back end processing applies one or more algorithms to refine the preliminary actual weights, wherein the one or more algorithms include spike removal, and wherein the back end processing includes stage identification, baby identification, comparative weight history analysis with respect to the baby or baby population, or combination thereof.

16. The system of claim 1, wherein the weight measurement data comprises processed measurement data including actual weight determined from removal of spikes beyond threshold values set relative to a mean weight measurement for each stage of the changing event or a percentage of a mean weight measurement for each stage of the changing event.

17. The system of claim 1, wherein the system is configured to process the weight measurement data including graphing the weight measurement data collected during the changing event and removing min and max spikes to identify weight in each stage of the changing event.

18. The system of claim 17, wherein max and min weight values are set as threshold amounts or percentages of a mean weight during an identified stage or changing event.

19. A method of tracking baby weight during changing events using a smart scale comprising a changing table platform, the method comprising:
detecting, with a weight sensor of the smart scale, weight applied to the platform to collect weight measurement data of a baby positioned on the platform during a changing event;
analyzing weight measurement data from a population of known babies for identification of patterns for correlation with the collected weight measurement data to identify the baby, wherein the correlation includes one or more of:
weight fluctuation patterns between weight measurements;
time of day of the current weight measurement with time of day of prior weight measurements;
identification of a timing pattern of urination or bowel movements of a particular baby or time period between diaper changes corresponding to a time period pattern between urination or bowel movements; or
comparison of a current measured weight of contents of a diaper to previous measured weights of contents of diapers for identified babies.
